(19) United States
(12) Patent Application Publication
(10) Pub. No.: US 2026/0120969 A1
(43) Pub. Date: Apr. 30, 2026

(54) ON-LOAD TAP CHANGER AND METHOD FOR OPERATING AN ON-LOAD TAP CHANGER

(71) Applicant: Hitachi Energy Ltd, Zürich (CH)

(72) Inventors: Kent OLSSON, Grangesberg (SE); Gunnar ANDERSSON, Nyhammar (SE); Jim ANDERSSON, Ludvika (SE)

(73) Assignee: Hitachi Energy Ltd, Zürich (CH)

(21) Appl. No.: 19/150,272

(22) PCT Filed: Sep. 6, 2023
(86) PCT No.: PCT/EP2023/074365

§ 371 Date: Jul. 23, 2025

(30) Foreign Application Priority Data
Jan. 23, 2023 (EP) 23152906.6

(51) Int. Cl. H01H 9/00

(52) U.S. Cl. CPC H01H 9/0016; H01H 9/0027

(57) ABSTRACT

An on-load tap changer includes a first tap selector, a second tap selector, a first diverter switch and a second diverter switch, wherein the diverter switches are connected to each other such that the tapped windings are connected in series, a first change over selector and a second change-over selector and one or more high-ohmic resistances in an electric connection between at least one of the diverter switches and at least one of the tapped windings.

### CROSS REFERENCE TO RELATED APPLICATIONS

This application is a 35 U.S.C. § 371 national stage application of PCT International Application No. PCT/EP2023/074365 filed on Sep. 6, 2023, which in turn claims foreign priority to European Patent Application No. 23152906.6, filed on Jan. 23, 2023, the disclosure and content of which is incorporated by reference herein in its entirety.

### TECHNICAL FIELD

The present disclosure relates to an on-load tap changer. The on-load tap changer may be used for regulating voltage in a transformer or a reactor.

### BACKGROUND

On-load tap changers are known in which two tapped windings are connected in series for obtaining a larger regulating range. Such connections are known from the standard IEEE C57.135-2011, for example. Also WO 2015/193011 A1 discloses a series connection of two tapped windings.

During an operation of a change-over selector, the tapped windings are galvanically disconnected and will become capacitively controlled by their surrounding potentials. This may lead to the change-over selectors being exposed to voltages above their withstand limits.

### SUMMARY

Embodiments of the disclosure relate to an improved on-load tap changer.

According to a first aspect, an on-load tap changer comprises a first tap selector for connection to a first tapped winding and a second tap selector for connection to a second tapped winding. The first tap selector is connected to a first diverter switch and the second tap selector is connected to a second diverter switch, wherein the diverter switches are connected to each other to connect the tapped windings in series. The on-load tap changer comprises one or more high-ohmic resistances in an electric connection between at least one of the diverter switches and at least one of the tapped windings.

The on-load tap changer further comprises a first change-over selector for connection to the first tapped winding and a second change-over selector for connection to the second tapped winding. The change-over selectors are provided for changing a connection of the tapped windings to a main winding. As examples, the change-over selectors may be in a plus/minus regulation or in a coarse/fine regulation. In a plus/minus regulation, the connection direction of the tapped windings to the main winding can be changed. In a coarse/fine regulation a coarse winding can be connected or disconnected from the tapped winding.

The tap selectors can be formed by two units or by two poles in one unit. Also the diverter switch can be formed by two units or by two poles in one unit. Accordingly, also the on-load tapchanger can be formed by two units or by two poles in one unit.

The on-load tap changer can be provided for accomplishing changes in transformer winding ratios or to change impedances in reactors. By the series connection of the tapped windings, a larger regulation range can be achieved.

By connecting the tapped windings to the diverter switches via the high-ohmic resistances, the tapped windings are connected to a defined potential during a change-over selector operation, i.e., when the change-over selector switches its contacts. Thereby, the voltage level to which the change-over selectors are exposed can be kept below a withstand limit.

The one or more high-ohmic resistances may comprise a first high-ohmic resistance and a second high-ohmic resistance. The first high-ohmic resistance may be located in an electric connection from a connection point between the diverter switches to the first tapped winding and the second high-ohmic resistance may be located in an electric connection from a connection point between the diverter switches to the second tapped winding. The connection point may be a common node.

The first and second high-ohmic resistances may be directly connected to the respective tapped windings. The first and second high-ohmic resistances may also be directly connected to each other. The first and second high-ohmic resistances may also be directly connected to the diverter switches. In this context, “directly connected” means that no further electric component is located in the electric connection line between the respective elements. However, a connection line to a further electric components may be branched off in the connection line between the respective elements.

The tapped windings may be additionally connected to each other via the one or more high-ohmic resistances. As an example, a connection line between the high-ohmic resistances and a connection line between the diverter switches may be connected by a further connection line.

A total resistance provided by one or more of the high-ohmic resistors between one of the tapped windings and one of the diverter switches may have a resistance value in a range from 50 kOhm to 500 kOhm, for example.

The on-load tap changer may comprise one or more resistance switches for establishing and interrupting the connection of the tapped windings to the diverter switches via the high-ohmic resistances. In normal operation of the electric facility, the resistance switches may be open such that the connection is interrupted and current flow and losses from the resistances are avoided. During a change-over selector operation, the switches are closed so that the tapped windings are at a defined potential.

According to a further aspect, an electrical facility comprises the on-load tap changer as described in the foregoing, the tapped windings and a main winding. The electrical facility is a transformer or a reactor. The first and second tapped windings are directly or indirectly connected to a transformer or a reactor main winding.

According to a further aspect, a method for operating the on-load tap changer and/or the electrical facility comprises opening at least one of the change-over selectors.

When the on-load tap changer comprises one or more resistance switches for establishing and interrupting the connection of the tapped windings to the diverter switches via the high-ohmic resistances, the method may comprise the step of interrupting the connection after the change-over selectors are again closed in a change-over selector operation. A change-over selector operation is a part of a tap change operation when the tap selectors are at a mid-position. Accordingly, the high-ohmic resistances can be connected only for a change-over selector operation and disconnected in normal operation. Thereby, additional losses during normal operation can be avoided.

### BRIEF DESCRIPTION OF THE DRAWINGS

The present disclosure comprises several aspects. Every feature described with respect to one of the aspects is also disclosed herein with respect to the other aspect, even if the respective feature is not explicitly mentioned in the context of the specific aspect.

Further features, refinements and expediencies become apparent from the following description of the exemplary embodiments in connection with the figures. In the figures, elements of the same structure and/or functionality may be referenced by the same reference signs. It is to be understood that the embodiments shown in the figures are illustrative representations and are not necessarily drawn to scale.

FIG. 1 shows an embodiment of on-load tap changer in a schematic diagram,

FIG. 2 shows a further embodiment of an on-load tap changer in a schematic diagram,

FIG. 3 shows a further embodiment of on-load tap changer in a schematic diagram,

FIG. 4 shows a further embodiment of an on-load tap changer in a schematic diagram, and

FIG. 5 shows steps in a method of operating an on-load tap changer in a schematic diagram.

### DETAILED DESCRIPTION

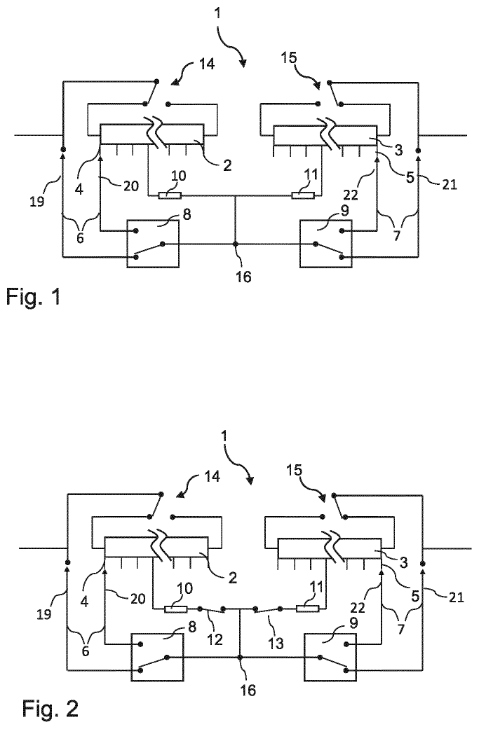

FIG. 1 shows a schematic diagram of an on-load tap changer 1 for regulating voltage in an electric facility. The electric facility is a transformer or a reactor. The transformer may be a power transformer or a phase shifting transformer, for example. The electric facility may be connected to a high voltage transmission line. The depicted circuit may be suitable for a reactor, for example.

The on-load tap changer 1 provides a series connection of a first tapped winding 2 and a second tapped winding 3. Each of the tapped windings 2, 3 comprises a plurality of taps 4, 5 for connecting or disconnecting parts of the winding directly or indirectly to or from a main winding of the electrical facility. By connecting two tapped windings 2, 3 in series, it is possible to achieve a larger regulation range, because the total voltage across a single regulating winding is limited.

Such an on-load tap changer arrangement can be achieved either by using an on-load tap changer unit with two poles which are connected to each other or by connecting two on-load tap changer units, for example. As an example, a two- or three-pole on-load tap changer can be used, wherein two poles are connected in series.

For each of the tapped windings 2, 3 a tap selector 6, 7, each comprising two contact arms, changes the tap in operation. Furthermore, change-over selectors 14, 15 are provided for changing a connection of a respective one of the tapped windings 2, 3 to a main winding.

As an example, the change-over selectors 14, 15 may be in the form of change-over selectors for reversing or disconnecting a tapped winding at mid-position operation. To obtain very large regulation ranges, the on-load tap changer 1 may have a plus/minus or coarse/fine configuration.

In the tapchanger 1 of FIG. 1, the change-over selectors 14, 15 are in a plus/minus regulation. In plus/minus regulation, either end of the tapped windings 2, 3 can be connected to the end of the main winding, so that a current flow in either direction can be selected. Thereby, a double regulating range can be achieved when compared to a regulating winding in linear regulation.

For each of the tapped windings 2, 3, a diverter switch 8, 9 is provided for transferring the load current from a first arm of the tap selector 6, 7 to a second arm of the tap selector 6, 7 in a tap change operation. The diverter switches 8, 9 may comprise transistor resistors, which are inserted during operation.

During a change-over selector operation, the tapped winding 2, 3 is galvanically disconnected and the potentials of the tapped winding 2, 3 will become capacitively controlled by its surrounding potentials. This may lead to that the change-over selector 14, 15 are exposed for too high capacitive voltages so that a safe operation cannot be ensured anymore. For this reason, costly winding layouts may have to be used.

In the shown embodiment, high-ohmic resistances 10, 11 are connected between a middle one of the taps 4, 5 of the tapped windings 2, 3 and the diverter switches 8, 9. In the shown embodiment, the high-ohmic resistances 10, 11 are connected to a common node 16 in the connection line between the diverter switches 8, 9. The high-ohmic resistances 10, 11 are directly connected to each other. An electric connection line between the high-ohmic resistances 10, 11 is connected to an electric connection line between the diverter switches 8, 9. The connection line between the tapped windings 2, 3 via the high-ohmic resistance 10, 11 may comprise no further components than the high-ohmic resistances 10, 11. The connection line between the diverter switches 8, 9 may comprise only the connection to the high-ohmic resistances 10, 11 but no further elements and no connection to further elements.

In other embodiments, further components may be provided in the connection line. It is further possible that only one high-ohmic resistance is present, e.g., in the vertical connection to the diverter switches 8, 9. It is also possible that the two ohmic resistances 10, 11 are not directly connected to each other before being connected to the connection line connecting the diverter switches 8, 9 but are separately to the connection line connecting the diverter switches 8, 9.

The high-ohmic resistances 10, 11 will connect the tapped windings 2, 3 to a defined potential and the tapped windings 2, 3 will not be galvanically disconnected during a change-over selector operation. The high-ohmic resistances 10, 11 can be also denoted as “tie-in resistors”.

By using the high-ohmic resistances 10, 11, a rise of the voltage above the withstand voltage over the change-over selector can be avoided and cost-efficient winding layouts can be used. Cost-efficient winding layouts means that by using high-ohmic resistances 10, 11 more options to physically locate the separate windings with respect to each other are available, without that the withstand voltage over the change-over selector 14, 15 is exceeded. As an example, two windings may have to be located on two separate concentric layers if high-ohmic resistances are not used. By using high-ohmic resistances the two windings may be located above each other in one and the same concentric layer. The latter layout is significantly more cost-efficient since each separate concentric winding layer adds size, material and labor cost to the transformer or reactor.

FIG. 2 shows a further embodiment of an on-load tap changer 1 in a schematic diagram. The circuit is similar to the embodiment of FIG. 1 but comprises resistance switches 12, 13 for connecting and disconnecting the tapped windings 2, 3 to the diverter switches 8, 9 via the high-ohmic resistances 10, 11.

When not carrying out a change-over by activating the change-over selectors 14, 15, the resistance switches 12, 13 can be open so that the high-ohmic resistances 10, 11 do not lead to increased losses during normal operation. During a change-over selector operation, the resistance switches 12, 13 are closed to avoid a galvanic disconnection of the tapped windings 2, 3.

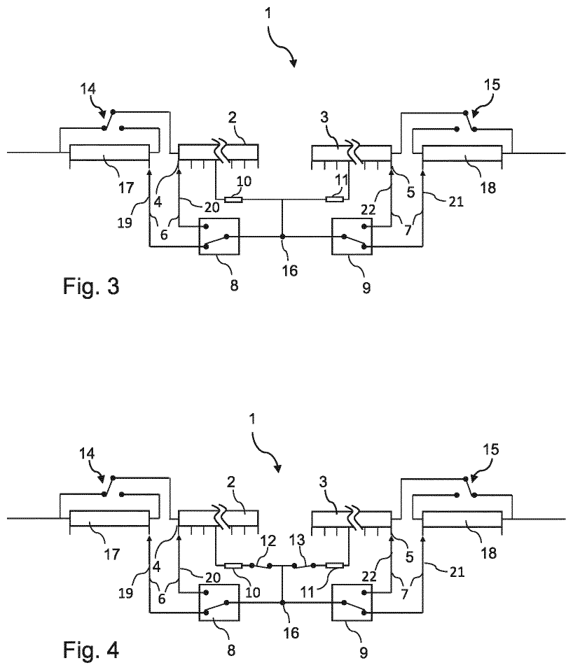

FIG. 3 shows a further embodiment of an on-load tap changer 1. In this embodiment, the change-over selectors 14, 15 provide a coarse/fine regulation. In this case, a first coarse winding 17 can be selectively added to the first tapped winding 2 and a second coarse winding 18 can be selectively added to the second tapped winding 3. Also in this embodiment, high-ohmic resistances 10, 11 are provided for preventing a high capacitive voltage across the change-over selectors 14, 15 during a change-over selector operation.

FIG. 4 shows a further embodiment of an on-load tap changer 1 with change-over selectors 14, 15 providing a coarse/fine regulation. As in the embodiment of FIG. 2, resistance switches 12, 13 are provided for establishing and interrupting the connection of the high-ohmic resistances 10, 11 to the diverter switches 8, 9.

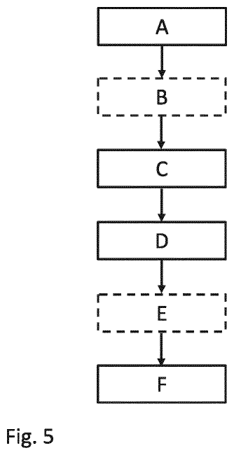

FIG. 5 shows a schematic diagram of steps in operating a change-over selector in a tap change operation. The on-load tap changer can be in accordance with the embodiments shown in the foregoing Figures.

During normal operation of the electric facility contact arms of the tap selectors 6, 7 are connected to fixed contacts which are connected to taps 4, 5 of the tapped windings 2, 3. The tapped windings 2, 3 are connected by the diverter switches 8, 9 in series.

The change-over selector is carrying the load current in all positions except the middle position, which is shown in the foregoing figures. In this position, the current flows directly from a main winding or coarse winding 17, 18 to the first arms 19, 21 of the tap selector 6, 7 without passing the change-over selector 14, 15 so that the change-over selector 14, 15 can be moved without interruptions or arcing.

The change-over selector operation can be divided into three steps for opening and three steps for closing when a resistance switch 12, 13 is used, otherwise two steps for opening and two steps for closing.

When a change-over selector operation is initiated in step A, a movable contact on one or both of the second arms 20, 22 disconnects from its fixed contact.

After that, in step B, the respective resistance switch 12, 13, if being used, establishes the connection of the tapped windings via the high-ohmic resistances 10, 11 to the diverter switches 8, 9. If a resistance switch(es) 12, 13 is not used, step B is left out in the operation.

After that, in step C, the respective change-over selector 14, 15 opens. Now the respective tapped winding 2, 3 is galvanically disconnected and its voltage is controlled by the capacitances and voltages to the surroundings and by the high-ohmic resistances 10, 11. When the change-over selector 14, 15 is open, the tapped windings 2, 3 are connected via the high-ohmic resistances 10, 11 to a defined potential, thereby preventing the change-over selectors 14, 15 being exposed to too high voltages.

After that, in step D, the respective change-over selector 14, 15 closes. The tapped winding 2, 3 is again galvanically connected.

After that, in step E, the respective resistance switch 12, 13, if being used, opens.

After that, in step F, the respective second arm 20, 22 closes. Now, the load current can be switched by the respective diverter switches 8, 9. Steps E and F can be in opposite order.

When the on-load tap changer 1 comprises the resistance switches 12, 13 as shown in FIGS. 2 and 4, the resistance switches 12, 13 are in an open position during normal operation. Thereby, current does not flow via the high-ohmic resistances 10, 11 during normal operation and additional losses can be avoided.

In some embodiments, both tap selectors 6, 7 are activated simultaneously in a change-over operation to disconnect their second arms 20, 22 at the same time. Also the change-over selectors 14, 15 may be activated simultaneously. As an example, in this case, the tap selectors 6, 7 may be configured as two poles of the same tap changer unit, and may be driven by a common drive mechanism. Also the change-over selectors 14, 15 may be configured as two poles of the same unit and may be driven by a common drive mechanism. The drive mechanism of the change-over selectors 14, 15 may be integrated in the drive mechanism of the respective tap selector 6, 7.

In other embodiments, only one tap selector 6, 7 and change-over selector 14, 15 is activated at a specific time in a change-over operation. Also only one of the change-over selectors 14, 15 may be activated at a specific time. As an example, in this case, the tap selectors 6, 7 may be configured as separate units and driven by separate drive mechanisms. Also the change-over selectors 14, 15 may be configured as separate units and driven by separate drive mechanisms. Also here, the drive mechanism of the change-over selectors 10, 11 may be integrated in the drive mechanism of the respective tap selector 6, 7.

Also the resistance switches 12, 13 may be operated simultaneously or only when the respective change-over selector 14, 15 is activated.

### REFERENCE SIGNS

1 on-load tap changer
2 first tapped winding
3 second tapped winding
4 tap of first tapped winding
tap of second tapped winding
6 first tap selector
7 second tap selector
8 first diverter switch
9 second diverter switch
first high-ohmic resistance
11 second high-ohmic resistance
12 resistance switch
13 resistance switch
14 first change-over selector
second change-over selector
16 node
17 first coarse winding
18 second coarse winding
19 first arm of first tap selector
second arm of first tap selector
21 first arm of second tap selector
22 second arm of second tap selector
A, B, C, D, E, F method steps

1. An on-load tap changer comprising:
a first tap selector for connection to a first tapped winding and a second tap selector for connection to a second tapped winding,
a first diverter switch and a second diverter switch being connected to the respective tap selectors, wherein the diverter switches are connected to each other to connect the tapped windings in series,
a first change-over selector for connection to the first tapped winding and a second change-over selector for connection to the second tapped winding, and
one or more high-ohmic resistances in an electric connection between at least one of the diverter switches and at least one of the tapped windings.

2. The on-load tap changer of claim 1,
wherein the high-ohmic resistances comprise a first high-ohmic resistance and a second high-ohmic resistance.

3. The on-load tap changer of claim 2,
wherein the first high-ohmic resistance is in an electric connection from a connection point between the diverter switches to the first tapped winding and the second high-ohmic resistance is in an electric connection from a connection point between the diverter switches to the second tapped winding.

4. The on-load tap changer of claim 2, wherein the first and second high-ohmic resistances are directly connected to each other.

5. The on-load tap changer of claim 1, wherein the tapped windings are configured to be connected to each other via the high-ohmic resistances.

6. The on-load tap changer of claim 1, wherein each of the high-ohmic resistances is configured to be directly connected to one of the tapped windings.

7. The on-load tap changer of claim 1, wherein a total resistance value provided by one or more of the high-ohmic resistances between one of the tap selectors and one of the diverter switches has a value in a range of 50 kOhm to 500 kOhm.

8. The on-load tap changer of claim 1, comprising one or more resistance switches for connecting and disconnecting the diverter switches via the high-ohmic resistances to at least one of the tapped windings.

9. An electrical facility comprising the on-load tap changer of claim 1, the first tapped winding, the second tapped winding and a main winding, wherein the first and/or second tapped winding are connected to the main winding.

10. The electrical facility of claim 9,
wherein the main winding is a transformer or a reactor winding.

11. A method for operating the on-load tap changer of claim 1,
the method comprising the step of opening at least one of the change-over selectors, wherein the tapped windings are configured to be connected via the high-ohmic resistances to the respective diverter switch when the respective change-over selector is open.

12. The method of claim 11,
wherein the on-load tap changer comprises one or more resistance switches for establishing and interrupting the connection of the tapped windings to the diverter switches via the high-ohmic resistances, wherein the connection is established before the change-over selectors are opened and the connection is interrupted after the change-over selectors are closed during a tap change.

13. A method for operating the electrical facility of claim 9, the method comprising the step of opening at least one of the change-over selectors, wherein the tapped windings are configured to be connected via the high-ohmic resistances to the respective diverter switch when the respective change-over selector is open.

14. A method for operating the electrical facility of claim 10, the method comprising the step of opening at least one of the change-over selectors, wherein the tapped windings are configured to be connected via the high-ohmic resistances to the respective diverter switch when the respective change-over selector is open.
